(19) United States
(12) Patent Application Publication
(10) Pub. No.: US 2017/0105424 A1
(43) Pub. Date: Apr. 20, 2017

(54) A METHOD FOR PROCESSING MILK

(71) Applicant: VALIO LTD, Helsinki (FI)

(72) Inventors: Harri KALLIOINEN, Haarajoki (FI); Jukka PARTTI, Laukaa (FI); Jukka ESKELINEN, Laukaa (FI)

(21) Appl. No.: 15/039,215

(22) PCT Filed: Nov. 25, 2014
(86) PCT No.: PCT/FI2014/050906

§ 371 Date: May 25, 2016

(30) Foreign Application Priority Data
Nov. 27, 2013 (FI) 20136184

(51) Int. Cl. A23C 9/142; A23C 9/12; A23C 7/04

(52) U.S. Cl. CPC A23C 9/1422; A23C 7/046; A23C 9/1206

(57) ABSTRACT

A method for processing milk, comprising the steps of: providing skim milk; separating the skim milk to provide two or more fractions; providing a part or all of the two or more fractions into at least two compositions; subjecting the at least two compositions to at least one microbial load reduction treatment, wherein the at least one microbial load reduction treatment is different for each composition, is disclosed. Also, a method for producing a milk product, wherein the milk product is composed at least from the two differently treated compositions is disclosed.

### FIELD OF THE INVENTION

The present invention relates to a method for processing milk and to a method for producing milk products.

### BACKGROUND OF THE INVENTION

It is a well-established practice in the production of dairy products that milk is heat treated in order to inactivate undesirable enzymes and destroy pathogenic and other harmful microorganisms present in milk and to provide dairy products that are non-hazardous to health and have good taste. There are various heat treatments commonly used in the art, which differ in the severity of the heat treatment. For example, thermization, pasteurization, ultrapasteurization and sterilization can be mentioned. Thermization is a mild heat treatment typically carried out at 57-68° C. for up to 40 minutes (for example 63-65° C. for 15 sec). Pasteurization is typically carried out at 72-75° C. for 15-20 sec (for example 72° C. for 15). Pasteurization can also be carried out at 63° C. for 30 minutes. For cream, pasteurization can be carried out at >80° C. for 1-2 sec. Ultra pasteurization or high pasteurization is typically carried out at 125-138° C. for 2-4 sec. Sterilization in container is the most severe heat treatment, typically carried out at 115-120° C. for 20-30 minutes, which destroys all micro-organisms. In addition to the above definitions, there are still further definitions for said heat treatments commonly used in the field. Different definitions are predominantly dependent on the country where the heat treatments are employed. Thus, there is not only one specific definition for each different heat treatment naturally used throughout in food industry. It is well known in the art that heat treatments, however, have also adverse effects on the dairy products, since they cause changes in nutritional value and organoleptic properties of the products. A suitable heat treatment is chosen on the basis of the intended use of the product while changes to the final product are desirably minimized.

Nowadays, a common procedure for producing milk products is so-called component production where milk is separated into different fractions by various techniques. Depending on the used technology, different milk components can be enriched into separate fractions. A milk product is then composed from the obtained fractions in appropriate ratios to provide a product of a desired composition and characteristics. After composing, the product is heat treated in a suitable manner and packaged in aseptic conditions.

WO 2004/110158 A1 discloses a method for processing milk wherein milk is separated into a creamy part and into a skimmed milk part. The skimmed part is microfiltrated to generate a permeate with low bacterial charge. The permeate is pasteurized, and the creamy part is high temperature pasteurized or combined with the permeate and pasteurized. Before the separation of milk into a creamy part and into a skimmed part, the milk is subjected to centrifugal clarification to reduce bacterial charge and somatic cells.

WO 2010/085957 A2 discloses a method for producing long shelf life milk or milk-related products, wherein a milk derivate is subjected to a treatment of physical separation of microorganisms followed by a high temperature treatment at 140-180° C. for at most 200 msec. The physical separation can be bactofugation and/or microfiltration.

WO 2012/010699 A1 discloses a method of producing long shelf life, packaged, lactose-reduced milk-related products, wherein a lactose-reduced milk-related feed is subjected to a high temperature (HT)-treatment at 140-180° C. for at most 200 msec and then packaged. The document further discloses that milk is subjected to ultrafiltration (UF) to provide an UF retentate and a UF permeate, and the UF permeate is further subjected to nanofiltration (NF) to provide a NF retentate and a NF permeate. The UF retentate or a combination of the UF retentate and the NF permeate can then be used as the lactose-reduced milk-related feed and subjected to said HT treatment.

WO 2009/000972 A1 discloses a process for producing well-preserving low-lactose or lactose-free milk products, wherein proteins and sugars of milk are separated into different fractions. Said fractions are separately subjected to a direct ultra high temperature (UHT) treatment and then combined to low-lactose or lactose-free products. It is reported that the plasmin enzyme system of milk can be inactivated and Maillard browning reactions can be avoided whereby defects in taste, colour and structure of ultra high temperature treated milk products can be avoided.

The drawback of the prior art methods is that the heat treatments performed in the production of the milk products are energy-intensive and incur significant expenses. The capacity of UHT equipment is limited by the capacity of the used heat treatment method.

We have now found an energy-saving method to produce milk products in accordance with the modern component manufacture in which milk products are composed from one or more fractions obtained from separation of milk.

### BRIEF DESCRIPTION OF THE INVENTION

In an aspect, the present invention provides a method for processing milk, comprising the steps of:

a) providing skim milk,

b) separating the skim milk to provide two or more fractions,

c) providing a part or all of the two or more fractions into at least two compositions,

d) subjecting the at least two compositions to at least one microbial load reduction treatment, wherein the at least one microbial load reduction treatment is different for each composition.

In another aspect, the present invention provides a method for producing a milk product, comprising the steps of:

a) providing skim milk,

b) separating the skim milk to provide two or more fractions,

c) providing a part or all of the two or more fractions into at least two compositions,

d) subjecting the at least two compositions to at least one microbial load reduction treatment, wherein the at least one microbial load reduction treatment is different for each composition,

e) composing the milk product at least from two differently treated compositions obtained in step d).

It was surprisingly found that milk products which are safe in terms of health can be prepared from fractions separated from skim milk, which are not all subjected to the same microbial load reduction treatment but different microbial load reduction treatments can be employed for the fractions used for preparing milk products. Some of the fractions can be combined and subjected together to a specific microbial load reduction treatment. The present invention is based on an idea that depending on the milk components included in the fraction or of a combination of the fractions, each fraction or the combination of the fractions is subjected to microbial load reduction treatment which is most suitable in each case. Generally, as mild microbial load reduction treatment as possible is employed in order to minimize chemical and physical changes in the milk components included in the fraction. When the content of composition is not a limiting factor, then more severe and usually less expensive microbial load reduction treatment is used. An example of microbial load reduction treatments typically used in the production of milk products are various heat treatments. For example, a fraction comprising protein, is subjected to a mild treatment to reduce microbial load, since protein is susceptible to damages. Especially, whey proteins are heat sensitive and severe heat treatments can result in denaturation of whey proteins. On the other hand, less susceptible fractions can be subjected to more severe treatments.

It is generally known that heat treatments are energy-intensive and, thus, incur expenses. Especially, expenses caused by a direct ultra high treatment (UHT) process typically used for preparing milk products with long shelf life are relatively high. An example of the process conditions typically described for the direct ultra high temperature treatment is temperatures over 125° C. to 160° C. and time frame of about 0.09 to 4 sec. Also other ranges of temperature and time for the UHT treatment are described in the art. In the direct UHT treatment, steam is directly introduced by infusion or injection to milk followed by cooling in a vacuum chamber and removal of the condensed steam. In the indirect UHT, milk is heated by means of heat exchangers and then cooled. Typically, the indirect UHT treatment is more economical than the direct UHT. The higher operating expenses of the direct UHT treatment compared to indirect UHT treatment and also to other heat treatment processes arise from thermal energy lost in the UHT equipment, when the milk product is rapidly cooled from the sterilization temperature to a post-processing temperature. Subsequently, milk is cooled by plate or tubular heat exchangers.

An advantage of the present invention is that it is not necessary to subject the final milk product composed of the separated fractions as a whole to an energy-intensive microbial load reduction treatment but a less energy-intensive treatments can be employed for some fractions used in the formation of a final product, i.e., only for a portion of a final product. Energy savings are achieved, since more economical microbial load reduction treatments can be used in the method for preparing a milk product. Furthermore, the production capacity of a direct UHT equipment can be increased by non-expensive way, approximately by 10% to 75% or even more. The amounts of process water, and of warm condensates and waste water produced in the manufacturing process can also be reduced.

The present invention thus provides an energy efficient method for processing milk and for the production of a milk product.

### DETAILED DESCRIPTION OF THE INVENTION

In an aspect, the present invention provides a method for processing milk, comprising the steps of:

a) providing skim milk,

b) separating the skim milk to provide two or more fractions,

c) providing a part or all of the two or more fractions into at least two compositions,

d) subjecting the at least two compositions to at least one microbial load reduction treatment, wherein the at least one microbial load reduction treatment is different for each composition.

In another aspect, the present invention provides a method for producing a milk product, comprising the steps of:

a) providing skim milk,

b) separating the skim milk to provide two or more fractions,

c) providing a part or all of the two or more fractions into at least two compositions,

d) subjecting the at least two compositions to at least one microbial load reduction treatment, wherein the at least one microbial load reduction treatment is different for each composition,

e) composing the milk product at least from two differently treated compositions obtained in step d).

Milk, which is skimmed for use as a raw material in the invention, can be obtained from animal or plant sources. Milk can be obtained from any animal that produces milk which is suitable for human consumption. Animal sources include, but are not limited to, human, cow, sheep, goat, camel, mare, buffalo, llama and deer. Plant sources of milk include, but are not limited to, soybean, oat, rice, almond and coconut. The skim milk raw material can be skim milk obtained from one source. The skim milk raw material can also be a mixture of skim milks obtained from two or more different sources.

Milk is skimmed in a manner conventionally used in the art. For example, milk separator, can be mentioned. The fat content of the skim milk can range from about 0% to about 0.5%. In an embodiment, the fat content is about 0.1%.

In the context of the present invention, the term “skim milk” encompasses raw milk obtained from the animal and/or plant sources as such, which is skimmed, and various skim milk products having varied protein and carbohydrate contents. The skim milk product can be acidified or fermented. Skim milk can be reconstituted/recombined from powder of animal and/or plant sources or from concentrate, or a combination of these, or a dilution of any one of these.

If desired, the original lactose content of the skim milk can be adjusted. In an embodiment, the lactose content of the skim milk is reduced. Lactose removal can be accomplished by any suitable means generally known in the art, including, but not limited to, enzymatic lactose hydrolysis, ultrafiltration, nanofiltration, ion exchange chromatography, precipitation, electrodialysis and centrifugation. Various techniques can be combined in an appropriate manner.

Skim milk can be supplemented or fortified, for example, with vitamins, minerals, aromas, etc.

In the method of the invention, the skim milk is separated into two or more fractions. The separation can be performed by chromatography, membrane filtration(s), evaporation, crystallization or a combination thereof. In an embodiment, the separation is performed by chromatography. In another embodiment, the separation is performed by membrane filtration(s). The membrane filtration is selected from microfiltration, ultrafiltration, nanofiltration, reverse osmosis and a combination thereof. Diafiltration can be used in any of the membrane filtration techniques. Generally, diafiltration means a membrane filtration process which is used to enhance the separation of the components. The diafiltration is carried out by adding water or permeate to a feed which is fed to a membrane filtration, or to a retentate obtained from the filtration, which is then re-filtered. Diafiltration technique is well-known to a skilled person in the art.

The separation step provides two or more fractions which each have a different composition compared with the overall composition of skim milk. In the context of the present invention, the overall composition of skim milk consists essentially of the following components: protein, carbohydrate, fat, minerals, vitamins and water. The composition of the separated fractions can differ from the overall composition of the skim milk in respect of a type of one or more milk components and/or a quantity of one or more milk components.

In an embodiment of the invention, the skim milk is divided into four fractions, i.e., a protein rich fraction, carbohydrate rich fraction, mineral rich fraction and water fraction. This can be carried out by microfiltration, ultrafiltration, nanofiltration or reverse osmosis, or by any combination thereof. In an embodiment, skim milk is separated into fractions by ultrafiltration, nanofiltration and reverse osmosis. The separation is appropriately carried out as follows: skim milk is subjected to ultrafiltration (UF) to provide an UF retentate and an UF permeate; the UF permeate is subjected to nanofiltration (NF) to provide a NF retentate and a NF permeate; the NF permeate is subjected to reverse osmosis (RO) to provide a RO retentate and a RO permeate. The protein rich fraction is obtained as the UF retentate, the carbohydrate rich fraction is obtained as the NF retentate, the mineral rich fraction is obtained as the RO retentate and the water fraction is obtained as the RO permeate.

In another embodiment of the invention, the skim milk is separated into two fractions. In an embodiment, skim milk is concentrated by reverse osmosis to provide a milk concentrate as a RO retentate and a water fraction as a RO permeate. In a further embodiment, the skim milk is separated into a two fractions by microfiltration (MF) to provide a casein-rich fraction as a MF retentate and a whey protein-rich fraction as a MF permeate. The various milk components included in the MF permeate can be further separated into different fractions by membrane filtration(s) as described above or by chromatography. In an embodiment, the MF permeate is ultrafiltrated to concentrate whey protein into an UF retentate. The obtained UF permeate is subjected by nanofiltration to concentrate carbohydrates into a NF retentate. The obtained NF permeate can be concentrated by reverse osmosis to provide a mineral rich fraction and water fraction.

When microfiltration is employed for fractionation of proteins, the microfiltration membrane has typically a pore size of 0.1 μm or below. In an embodiment, the size is 0.08 μm (800 kDa). When microfiltration is employed for reduction of microbial load, the microfiltration membrane has typically a pore size of 0.1 μm to 1.4 μm. In an embodiment, the size is 0.8 μm.

The membrane filtrations can be carried out at a temperature range of about 1° C. to about 55° C.

In chromatographic separation of milk, typically two fractions, i.e. a protein rich fraction and carbohydrate rich fraction, are obtained.

The two or more fractions obtained in the separation of milk are provided into at least two compositions. In an embodiment, a part of the fractions obtained from the separation is provided into the at least two compositions. In another embodiment, all of the fractions obtained from the separation are provided into the at least two compositions.

In an embodiment, each fraction is present in only one composition at a time. In another embodiment, one single fraction can be divided into two or more compositions.

In an embodiment of the invention, a part of the separated fractions is provided in two compositions, i.e. a first composition and a second composition. In an embodiment, each fraction is provided either in the first composition or in the second composition.

In an embodiment, the first composition comprises substantially all milk protein. In another embodiment, the first composition comprises substantially all milk casein. In an embodiment, the first composition comprises an UF retentate obtained from ultrafiltration of skim milk. In another embodiment, the first composition comprises a MF retentate obtained from microfiltration of skim milk. In a further embodiment, the first composition comprises an RO retentate obtained from reverse osmosis treatment of skim milk. In still a further embodiment, the first composition comprises a protein rich fraction obtained from chromatographic separation of skim milk. The first composition can further comprise mineral rich fraction, such as a RO retentate. The first composition can further comprise milk fat, such as cream, and/or milk having varied fat, protein and lactose content, such as skim milk.

In an embodiment, the second composition is substantially free of milk protein. In another embodiment, the second composition is substantially free of milk casein. In an embodiment, the second composition is essentially composed of water, such as a RO permeate. In an embodiment, the second composition comprises a carbohydrate rich fraction, such as a NF retentate. In another embodiment, the second composition comprises a carbohydrate rich fraction and water fraction, such as NF retentate and RO permeate, respectively. In a further embodiment, the second composition comprises whey protein rich fraction and water fraction, such MF permeate, which is optionally concentrated, for example, by ultrafiltration, and RO permeate, respectively. In a still further embodiment, the second composition comprises a carbohydrate rich fraction obtained from chromatographic separation of skim milk.

The two or more compositions prepared from a part or all of the separated fractions are subjected to at least one microbial load reduction treatment. In an embodiment, each composition is subjected to one single microbial load treatment. The microbial load reduction treatment is different for each composition. The microbial load reduction treatment employed in the method of the invention includes, but is not limited to, physical separation and heat treatments and a combination thereof. The physical separation includes, but is not limited to, microfiltration, sterile dead-end filtration using polymeric or ceramic membranes, and bactofugation. Also other microbe removal methods, such as an ultraviolet treatment, HPP (high pressure processing) and PEF (pulsed electric field treatment) can be used in the present invention.

Heat treatments include, but are not limited to, pasteurization, high pasteurization, or heating at a temperature lower than the pasteurization temperature for a sufficiently long time. For example, UHT treatment (e.g. milk at 138° C., 2 to 4 sec), ESL treatment (e.g. milk at 130° C., 1 to 2 sec), pasteurization (e.g. milk at 72° C., 15 sec), thermisation (e.g. at 65° C., 2 sec to 3 min) and high pasteurization (95° C., 5 min) can be mentioned. Also, heat treatment at 140-180° C. for 0.2 sec is suitable. As stated above, other temperature and time ranges for each specific heat treatment are described in the art and can be used in the present invention as well. The heat treatment can be either direct (steam to milk, milk to steam) or indirect (tube heat exchanger, plate heat exchanger, scraped-surface heat exchanger).

In an embodiment, a composition comprising one or more fractions obtained from the separation is subjected to one microbial load reduction treatment. In another embodiment, the composition is subjected to two microbial load reduction treatments. In an embodiment, the first and the second compositions each are subjected to one microbial load reduction treatment. In another embodiment, the first composition is subjected to one microbial load reduction treatment and the second composition is subjected to two microbial load reduction treatments.

In an embodiment of the invention, the first composition is subjected to direct UHT treatment and the second composition is subjected to a microbial load reduction treatment selected from an indirect UHT treatment, pasteurization, microfiltration or sterile dead-end filtration and a combination thereof. In an embodiment, the second composition is subjected to microfiltration and pasteurization.

In an embodiment, at least 10% by volume, specifically at least 20% by volume, more specifically at least 30% by volume, based on the total volume of the milk product, is subjected to one heat treatment procedure.

In an embodiment, the methods of the invention comprise a lactose hydrolysis step. Lactose can be hydrolyzed at any stage of the methods. In an embodiment, the skim milk is lactose hydrolyzed prior to the separation step b). In another embodiment, the lactose hydrolysis step is performed on the milk product obtained in step d). In an embodiment, the milk product is low-lactose having a lactose content of at most 1%. In another embodiment, the milk product is lactose-free having a lactose content of at most 0.01%.

In an embodiment, the milk product prepared by the method of the invention is packaged in aseptic conditions.

The milk product prepared by the method of the invention can be dried to powder or further processed to other milk products, including fermented and sour milk products, such as yoghurt, fermented milk, viili, fermented cream, sour cream, quark, butter milk, kefir, dairy shot drinks and cream cheese, or ice cream.

The following examples are presented for further illustration of the invention without limiting the invention thereto.

### EXAMPLES

### Example 1

Skim milk was ultrafiltrated by a concentration factor of 3.5 at a temperature of 10° C. using Synder ST membrane. The obtained ultrafiltration permeate was nanofiltrated by a concentration factor of 4 at a temperature of 10° C. using Parker ATF membrane. The obtained nanofiltration permeate was concentrated by reverse osmosis by a concentration factor of 10 at a temperature of 10° C. using Filmtech RO membrane. Composition of the skim milk and of the fractions obtained from the above membrane filtrations are given in Table 1. Table 1 further shows the composition of cream used for composing milk products.

TABLE 1

| | Skim | UF | UF | NF | NF | RO | RO | |
|---|---|---|---|---|---|---|---|---|
| | milk | ret. | perm. | ret. | perm. | ret. | perm. | Cream |
| Protein (%) | 3.6 | 12.2 | 0.2* | 0.4* | <0.2 | 0.2 | <0.2 | 2.3 |
| Casein | 80 | | | | | | | |
| Whey | 20 | | | | | | | |
| protein | | | | | | | | |
| Fat (%) | <0.1 | 0.2 | <0.1 | <0.1 | <0.1 | <0.1 | <0.1 | 35.0 |
| Lactose (%) | 4.7 | 4.4 | 4.6 | 17.9 | <0.1 | 0.3 | <0.2 | 3.0 |
| Ash (%) | 0.8 | 1.5 | 0.5 | 1.3 | 0.2 | 1.7 | <0.2 | 0.5 |

*non protein nitrogen (NPN)

Fractions illustrated in Table 1 were used for preparing various milk products in accordance with Table 2.

TABLE 2

| | Lactose-free skim | | |
|---|---|---|---|
| | milk drink | High protein milk | Low-fat milk |
| | Proportion (%) | | |
| Skim milk | 54.1 | — | — |
| Cream | — | — | 4.2 |
| UF retentate | 12.8 | 40.0 | 27.4 |
| UF permeate | — | 60.0 | — |
| NF retentate | — | — | 17.1 |
| NF permeate | — | — | 51.3 |
| RO retentate | 7.5 | — | — |
| RO permeate | 25.6 | — | — |
| | Composition (%) | | |
| Protein | 3.5 | 5.0 | 3.5 |
| Fat | 0.06 | 0.06 | 1.5 |
| Carbohydrate | 3.1 | 4.7 | 4.5 |
| Ash | 0.8 | 0.9 | 0.8 |

The products were prepared as follows:

### Lactose-Free Skim Milk

Skim milk, the UF retentate and the RO retentate were combined together to form a mixture. 0.12% of a lactase enzyme (Godo YNL2) was added to the mixture. Lactose hydrolysis was carried out at 7° C. to hydrolyze all lactose present in the mixture. The hydrolyzed mixture was heat-treated by direct steam injection (UHT infusion equipment from SPX, Denmark) at 135° C. for 0.5 sec.

The RO permeate was heat-treated by an indirect high heat treatment plate exchanger equipment at 130° C. for 3 sec. The heat-treated RO permeate was aseptically combined with the lactose-hydrolyzed heat-treated mixture to provide a lactose-free milk skim milk product.

### High Protein Milk

The UF retentate was heat-treated by direct steam infusion (UHT infusion equipment from SPX, Denmark) at 135° C. for 0.5 sec. The UF permeate was heat-treated by an indirect high heat treatment plate exchanger equipment at 130° C. for 3 sec. The UF retentate and the UF permeate were then aseptically combined together to form high protein milk.

### Low-Fat UHT Milk

The NF retentate and the NF permeate were combined together to form a first mixture. The first mixture was indirectly ultra high temperature treated with a GEA plate heat exchanger at 143° C. for 4 sec. The UF retentate was mixed with cream to form a second mixture. The second mixture was ultra high temperature treated by direct steam injection (Tetra Pak) at 143° C. for 4 sec. The first and the second mixture were then aseptically combined to form low-fat UHT milk having a carbohydrate content of 4.5%.

Subsequently, low-lactose low-fat milk was prepared by aseptically adding 0.002% of a lactase enzyme (Maxilact LGX5000, DSM) to the low-fat UHT milk prepared above by means of sterile filtration (Pall flurodyne II membrane of 0.2 μm). Lactose hydrolysis was carried out at a room temperature. In three days, a lactose content of at most 1% was achieved.

Further, low-fat ESL milk having a similar composition to that of lowfat UHT milk and described in Table 2 was prepared from the fractions as follows:

### Low-Fat ESL Milk

The NF retentate and the NF permeate were combined together to form a first mixture. The first mixture was indirectly ultra high temperature treated with a plate heat exchanger at 135° C. for 3 sec. The UF retentate was mixed with cream to form a second mixture. The second mixture was treated by direct steam infusion (SPX) at 135° C. for 0.5 sec. The first and the second mixture were then aseptically combined to form low-fat milk having a carbohydrate content of 4.5%.

A reference low-fat ESL milk was prepared by heat-treating semi skimmed milk as such by direct steam infusion (SPX) at 135° C. for 0.5 sec.

The plasmin activity of the low-fat ESL milk of the invention and that of reference low-fat ESL milk was determined. The plasmin activity of the lowfat milk of the invention (32 μmol/gh) was 30% lower than that of reference low-fat milk (47 μmol/gh).

### Example 2

Skim milk was concentrated by reverse osmosis (RO) by concentration factor 2.2 with a Koch HR membrane to provide a milk concentrate as a RO retentate and a RO permeate substantially composed of water. The milk concentrate was ultra high temperature treated with a direct steam injector (Tetra Pak) at 127° C. for 2 sec. The RO permeate was sterile filtrated using a Fuente dead-end filter of 0.2 μm from Pall Corp. The RO retentate and the RO permeate treated as above were then aseptically combined together to form skim milk which has a composition similar to that of skim milk used as a raw material.

### Example 3

Skim milk was microfiltrated (MF) by a concentration factor of 3.8 with a Synder FR membrane of 0.08 μm (800 kDa) at a temperature of 55° C. and at a pressure of <1.5 bar to concentrate casein into a MF retentate. 25% by volume of water, based on the volume of the MF retentate, was introduced to the retentate. The mixture was diafiltrated under the same process conditions until a permeate was produced in an amount corresponding to the added amount of water. The diafiltration was repeated three times. The obtained diafiltration permeate was collected and concentrated by ultrafiltration (UF) at 50° C. using a Synder ST membrane of 10 000 Da until a protein content of 8.2% of the UF retentate was achieved. The obtained UF permeate was nanofiltrated (NF) to provide a NF retentate and a NF permeate, and the NF permeate was concentrated by reverse osmosis under the process conditions given in Example 1.

Compositions of the skim milk and the fractions obtained from the above membrane filtrations are given in Table 3.

TABLE 3

| | Skim | MF | UF | NF | RO | RO |
|---|---|---|---|---|---|---|
| | milk | ret. | ret. | ret. | ret. | perm. |
| Protein (%) | 3.6 | 14 | 8.2 | 0.4* | 0.2* | <0.2 |
| Casein | 80 | | | | | |
| Whey | 20 | | | | | |
| protein | | | | | | |
| Fat (%) | 0.06 | 0.3 | <0.1 | <0.1 | <0.1 | <0.1 |
| Carbohydrate | 4.7 | 0.2 | 2 | 18 | 0.3 | <0.2 |
| (%) | | | | | | |
| Ash (%) | 0.8 | 1.3 | 0.4 | 1.3 | 1.7 | <0.2 |

*non protein nitrogen (NPN)

Fractions illustrated in Table 3 were used for preparing various milk products in accordance with Table 4.

TABLE 4

| | |
|---|---|
| Milk product 1 | Milk product 2 |

Proportion (%)

| | | |
|---|---|---|
| MF retentate | 24 | 25 |
| UF retentate | 56 | — |
| NF retentate | — | 25 |
| RO permeate | 20 | 50 |

Composition (%)

| | | |
|---|---|---|
| Protein | 8.0 | 3.5 |
| Protein | 8.0 | 3.5 |
| Casein | 50 | >90 |
| Whey protein | 50 | <10 |
| Fat | <0.1 | <0.1 |
| Lactose | 1.7 | 4.6 |
| Ash | 0.4 | 0.7 |

The products were prepared as follows:

### Milk Product 1

The MF retentate was ultra high temperature treated in a direct infusion UHT equipment (SPX) at 150° C. for 3 sec. The UF retentate and the RO permeate, which is essentially composed of water, were combined to form a mixture. The mixture was microfiltrated by a concentration factor of 100 with a ceramic GEA filter of 0.8 μm to reduce microbial load thereof. The obtained MF permeate was pasteurized at 72° C. for 15 sec. The MF retentate was discarded. The UHT-treated MF retentate and the pasteurized MF permeate were then mixed to form milk product 1.

### Milk Product 2

The MF retentate was ultra high temperature treated in a direct infusion UHT equipment (SPX) at 157° C. for <0.2 sec. The NF retentate and RO permeate, which is essentially composed of water, were combined to form a mixture. The mixture was ultra high temperature treated in an indirect UHT plant at 135° C. for 3 sec. The MF retentate and the mixture were then aseptically combined to form milk product 2.

### Example 4

Skim milk was evaporated to a total solids of 30%. The obtained milk concentrate was run through a chromatographic column packed with 30.000 L of strong cation exchange resin (Finex Oy). The charge of the resin was balanced so as to conform to that of the skim milk. 13.3% by volume of the milk concentrate, based on the volume of the resin, was supplied to the column and eluated with water at 60-65° C. Eluated milk was collected so that substantially all protein was recovered in a first fraction and substantially all lactose was recovered in a second fraction. Composition of the two fractions from the chromatographic separation is given in Table 5.

TABLE 5

| | Protein fraction | Lactose fraction |
|---|---|---|
| Protein (%) | 5.8 | 0.1 |
| Fat (%) | 0.1 | <0.1 |
| Lactose (%) | 1.7 | 11.2 |
| Ash (%) | 1.3 | <0.2 |

Fractions illustrated in Table 5 were used for preparing a milk product in accordance with Table 6 as follows: the protein fraction was treated in a direct infusion UHT equipment (SPX) at 135° C. for 1 sec. The lactose fraction was combined with water and then heat-treated by an indirect heat exchanger at 110° C. for 6 sec. The protein fraction and the combination of lactose fraction and water, which are heat-treated as described, are then aseptically combined to a milk product.

TABLE 6

| | Milk product |
|---|---|
| | Proportion (%) |
| Protein fraction | 60 |
| Lactose fraction | 30 |
| Tap water | 10 |
| | Composition (%) |
| Protein | 3.5 |
| Fat | <0.1 |
| Lactose | 4.6 |
| Ash | 0.8 |

### Energy Calculation

In direct UHT technique, skim milk is heated indirectly to a temperature of 75° C. and subsequently directly to a temperature of 150° C. by steam heating. Heat energy needed to raise the temperature from 75° C. to 150° C. is calculated as follows:

Δh=h_{milk 150° C.}−h_{milk 75° C.}=310 kJ/kg

In direct steam heating, internal latent heat of steam is used. The internal latent heat of saturated steam of 150° C. is 2,115 kJ/kg. Thus, in theory, food-grade steam needed for skim milk is 0.147 kg/kg skim milk.

After 3 seconds at 150° C., the temperature of skim milk is reduced in a vacuum chamber so as to vaporize a corresponding amount of water. This temperature is about as low as the pre-heating temperature of 75° C. It is challenging to utilize the heat energy of steam because of, i.a., product residues optionally present in steam. For that reason steam is typically condensed and the condensate is sewered. The heat energy is not used in a regenerative step of the indirect heat exchange step.

Typically, 90% of the heat energy used in the indirect heat treatment can be utilized by means of regeneration. In direct steam heat treatment, the degree of regeneration is typically at most about 50% depending on the temperature difference between pre-heating and heat treatment temperature. In addition, higher quality requirements exist for steam used in the direct steam heating than that used in the indirect process.

It will be obvious to a person skilled in the art that, as the technology advances, the inventive concept can be implemented in various ways. The invention and its embodiments are not limited to the examples described above but may vary within the scope of the claims.

1-18. (canceled)

19. A method for processing milk, comprising the steps of:
a) providing skim milk,
b) separating the skim milk to provide two or more fractions, the two or more fractions each having a different composition compared with the overall composition of the skim milk,
c) providing a part or all of the two or more fractions into at least two compositions,
d) subjecting the at least two compositions to at least one microbial load reduction treatment, wherein the at least one microbial load reduction treatment is different for each composition.

20. A method for producing a milk product, comprising the steps of:
a) providing skim milk,
b) separating the skim milk to provide two or more fractions, the two or more fractions each having a different composition compared with the overall composition of the skim milk,
c) providing a part or all of the two or more fractions into at least two compositions,
d) subjecting the at least two compositions to at least one microbial load reduction treatment, wherein the at least one microbial load reduction treatment is different for each composition,
e) composing the milk product at least from two differently treated compositions obtained in step d).

21. The method of claim 19, wherein the composition of the two or more fractions differs from the overall composition of the skim milk in respect of a type of one or more milk components and/or a quantity of one or more milk components.

22. The method of claim 19, wherein the fat content of the skim milk is in the range of about 0% to about 0.5%, specifically about 0.1%.

23. The method of claim 19, wherein each fraction is present in only one composition at a time.

24. The method of claim 19, wherein the separation is performed by chromatography, evaporation, crystallization and/or membrane filtration(s).

25. The method of claim 20, wherein the separation is performed by chromatography, evaporation, crystallization and/or membrane filtration(s).

26. The method of claim 24, wherein the membrane filtration is selected from microfiltration, ultrafiltration, nanofiltration, reverse osmosis and a combination thereof.

27. The method of claim 19, wherein two compositions, defined as a first composition and a second composition, are provided in step c).

28. The method of claim 20, wherein two compositions, defined as a first composition and a second composition, are provided in step c).

29. The method of claim 27, wherein a part of the fractions is provided in the two compositions.

30. The method of claim 19, wherein the microbial load reduction treatment is selected from physical separation, heat treatments and a combination thereof.

31. The method of claim 20, wherein the microbial load reduction treatment is selected from physical separation, heat treatments and a combination thereof.

32. The method of claim 30, wherein the physical separation is selected from microfiltration, sterile dead-end filtration using polymeric or ceramic membranes, and bactofugation.

33. The method of claim 30, wherein the heat treatments are selected from pasteurization, high pasteurization, direct UHT treatment, indirect UHT treatment, ESL treatment and thermisation or a combination thereof.

34. The method of claim 27, wherein the first composition is subjected to a direct UHT treatment.

35. The method of any one of claims 27, wherein the second composition is subjected to a microbial load reduction treatment selected from an indirect UHT treatment, pasteurization, microfiltration or sterile dead-end filtration and a combination thereof.

36. The method of claim 28, wherein the milk product is composed from the first composition and the second composition.

37. The method of claim 19, wherein at least 10% by volume, specifically at least 20% by volume, more specifically at least 30% by volume, based on the total volume of the milk product, is subjected to one heat treatment procedure.

38. The method of claim 19, further comprising a lactose hydrolysis step.

39. The method of claim 20, further comprising an aseptic packaging step of the milk product.
